(19) United States
(12) Patent Application Publication
(10) Pub. No.: US 2010/0085360 A1
(43) Pub. Date: Apr. 8, 2010

(54) RENDERING IN SCATTERING MEDIA

(75) Inventors: Zhong Ren, Beijing (CN); Kun Zhou, Beijing (CN); Stephen Lin, Beijing (CN); Baining Guo, Beijing (CN)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/245,708

(22) Filed: Oct. 4, 2008

(51) Int. Cl. G06T 15/50

(52) U.S. Cl. 345/426

(57) ABSTRACT

Techniques are described for rendering a volume of scattering media, in particular by computing radiances of points or voxels in the scattering media. A set of sample points in the scattering media are found. Radiances of the sample points are computed. Radiance gradients of the sample points are computed from the radiances. The radiances and gradients are used to interpolate radiances throughout the scattering media. The set of sample points may be computed in an iterative dynamic manner in order to concentrate samples near features (e.g., shadow edges) of the scattering media.

### BACKGROUND

The transport of light within a volume of scattering media such as fog, steam, particulate clouds, or liquids can produce volumetric shading effects that, if well reconstructed by rendering, increase realism. FIG. 1 shows an example rendered scene 100 including a light source 102, a volumetric medium 104 (the steam rising from the bowl), and various shading effects resulting from interaction of the light source 102, the medium 104, and objects in the scene 100. When rendering a volume of scattering media, effects such as glows around a light source and shafts of directional light can reveal the density variations of the medium and the structure of the illumination. Mutually cast shadows between scene objects and the medium provide further cues for perceiving the organization and properties of the scene. For example, see shadow 106 in scene 100.

Volumetric shading effects can be accurately reconstructed by a full Monte Carlo simulation. However, Monte Carlo simulation is too costly for real time use. To date, there has been no success in computing lighting in a volume of scattering media in a way that is both realistic and fast enough for real time use, where, for example, a volume of scattering media, light source, and or scene objects change from frame to frame, as during a 3D game. While some techniques for real time estimation exist, they are incapable of accurately constructing high frequency close-up details. Furthermore, in real time order of efficiency, sharp shading variations (e.g., the edges of a volumetric shadow in a medium) have not been accurately computed and generally produce noticeable rendering artifacts.

Techniques discussed below relate to rendering light in scattering media in ways that are both accurate and sufficiently efficient for use in real time rendering.

### SUMMARY

The following summary is included only to introduce some concepts discussed in the Detailed Description below. This summary is not comprehensive and is not intended to delineate the scope of the claimed subject matter, which is set forth by the claims presented at the end.

Techniques are described for rendering a volume of scattering media, in particular by computing radiances of points or voxels in the scattering media. A set of sample points in the scattering media are found. Radiances of the sample points are computed. Radiance gradients of the sample points are computed from the radiances. The radiances and gradients are used to interpolate radiances throughout the scattering media. The set of sample points may be computed in an iterative dynamic manner in order to concentrate samples near features (e.g., shadow edges) of the scattering media.

Many of the attendant features will be explained below with reference to the following detailed description considered in connection with the accompanying drawings.

### BRIEF DESCRIPTION OF THE DRAWINGS

The present description will be better understood from the following detailed description read in light of the accompanying drawings, wherein like reference numerals are used to designate like parts in the accompanying description.

FIG. 1 shows an example rendered scene 100.

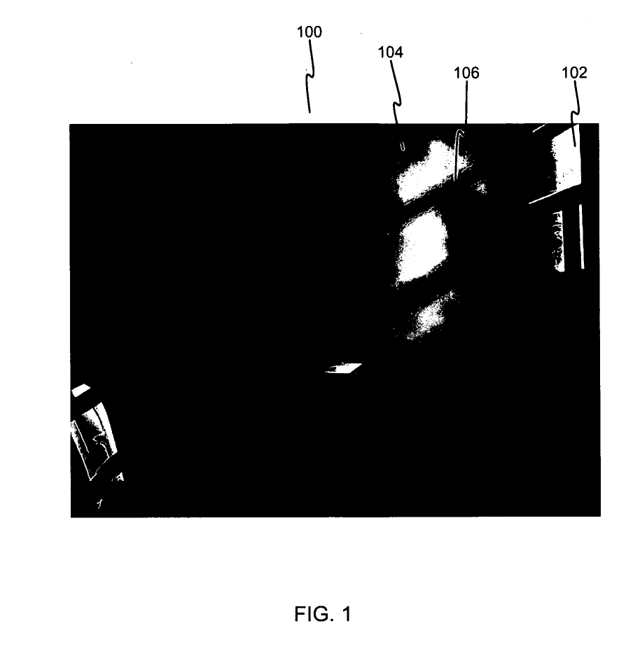

FIG. 2 shows a general algorithm for rendering a volume of scattering media.

FIG. 3 shows a lighting model.

FIG. 4 shows an example of a rendered scene showing a set of sample points computed using dynamic sampling.

FIG. 5 shows a process for dynamically sampling points in a volume of media.

FIG. 6 shows a general process for computing shading error for a sample point.

FIG. 7 shows a general process for gradient-based interpolation.

FIG. 8 shows an example computing device on which various methods described herein may be implemented.

### DETAILED DESCRIPTION

### Overview

Embodiments discussed below relate to rendering volumes of scattering media in ways that may account for sharp variations of shading in the volumes. Sample points may be dynamically distributed in a medium in a manner that allows for accurate reconstruction of source radiance by interpolation and which avoids or minimizes many shading errors in the rendered result, such errors often resulting from under-sampling. Areas in the medium with samples whose reconstructed source radiance result in significant shading errors end up with more sample points, which may improve rendering accuracy. Other areas are lightly sampled to save computation. Given such a set of sample points (whether by dynamic sampling or otherwise), radiances for rendering the volume may be obtained by computing, at each of the sample points, a point's source radiance and gradient thereof, which are then used to accurately interpolate source radiances of other points in the volume. The computation of source radiances may be followed by a ray march to composite the final radiances along view rays.

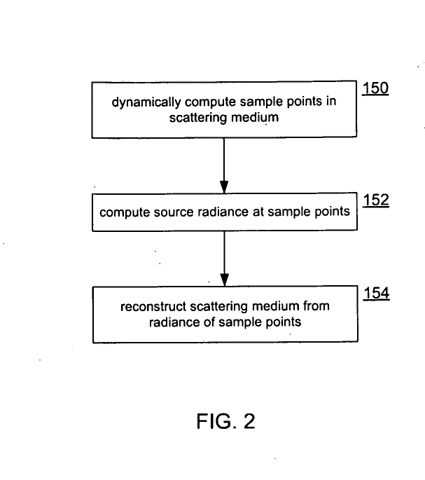

FIG. 2 shows a general algorithm for rendering a volume of scattering media. Before discussing FIG. 2, some terminology will be explained. Media to be rendered will be referred to, variously, as media volume, volumetric media, scattering media, or simply a medium. A medium models some real world phenomena such as steam, airborne particles, liquid, or even semi-transparent solids. A medium may have non-uniform density (i.e., a density field) and the density may vary over time (as billowing smoke, for example). Volumetric media is assumed to be scattering media, that is, media that scatters light. For simplicity, media is assumed to be (but not limited to) single scattering, meaning light radiated from a point in a medium is viewed directly rather than being further scattered by the medium.

Referring again to FIG. 2, in the case of real time animation rendering, the process of FIG. 2 may be performed for each frame to be rendered. The process begins by dynamically computing 150 a given number of sample points in a scattering medium. The sample points may be a relatively small subset of points in the medium, distributed in a way to approximate the structure of the medium. Source radiances of the sample points are then computed 152. Given the sample points and their source radiances, the scattering medium is reconstructed 154 by interpolation, which may be based in part on radiance gradients. That is, radiances for points or voxels in the medium (that are not sample points) are computed by interpolating from the known radiances. The remaining description below will proceed first with an explanation of a lighting model upon which equations for these steps may be based. Dynamic computation of sample points will then be explained, followed by explanation of how to reconstruct a medium volume from sample points and their radiances. Various implementation details will then be described.

### Lighting Model

This section describes a lighting model and density field representation (of a scattering medium) as well as a brief overview of a rendering algorithm based on the lighting model.

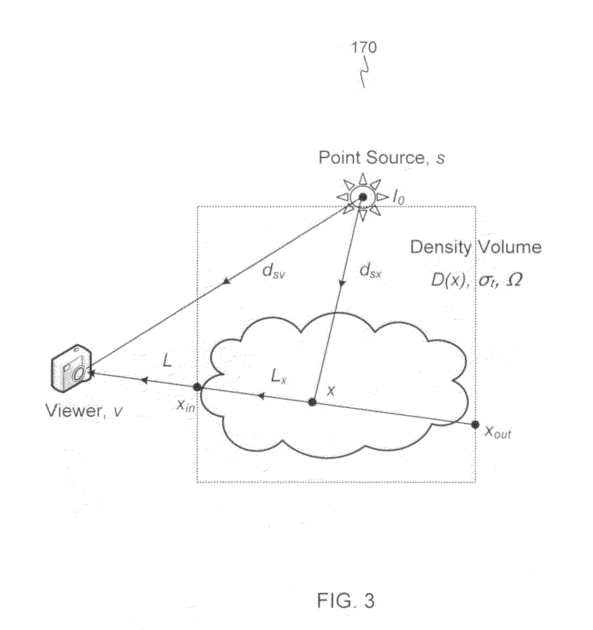

FIG. 3 shows a lighting model 170 for a simple point light source s as seen by a viewer v. The lighting model 170 pertains to light transport within a medium, which may be represented by a density field D defined in a volume V. The medium is presumed to be inhomogeneous. The volume V is considered to contain a single medium, whose parameters include an extinction cross section σₜ, a scattering cross section σₛ, and a scattering albedo Ω=σₛ/σₜ. The medium is assumed to be single scattering, such that radiance reaching the viewer has undergone at most one scattering interaction in the medium, and that the scattering is isotropic, i.e., uniform in all directions. While the example lighting model 170 uses a point source s, lighting for other source types of sources can be readily derived.

Source radiance for a point x in the density volume describes the local production of radiance that is directed towards the viewer v from point x. For a point source s and an isotropic, single scattering medium, source radiance for x can be computed as:

$${L}_{x} = \frac{{I}_{0}}{4 π {d}_{sx}^{2}} {τ}_{sx} \qquad ( 1 )$$

where I₀ is the point source intensity, d_{ab} denotes the distance from point a to b, and the transmittance τ_{ab} models the reduction of radiance due to extinction from point

e^{-σ}^{ₜ}^{∫}^{ₐ}^{^{b}}^{D(x)dx}

a to b, computed as

In terms of source radiance, the radiance L seen at the viewer v can be computed as

$$L = \frac{{I}_{0}}{{d}_{sv}^{2}} {τ}_{sv} + \frac{Ω}{4 π} {\int }_{{x}_{out}}^{{x}_{i n}} D ( x ) {L}_{x} {τ}_{xv} d x \qquad ( 2 )$$

where the first term describes direct transmission of radiance from the light source I₀ to the viewer, and the second term accounts for single scattered radiance from x in the medium (the combined radiances of multiple such points causes glow around a light source in the medium). Note that for a point light source s, the first term in Equation (2) contributes at most a single point on the screen. In the second term, source radiances are modulated by media density and transmittance before being integrated along view rays (rays on the xₒᵤₜ-xᵢₙ line and pointing to the viewer v). An extension of Equation (2) to volumes containing scene objects will be described further below.

Regarding representation of the density field D, to compactly represent the density field D, a Gaussian model with residuals may be used. Density is represented by a weighted sum of Gaussians and a hashed residual field F:

$$D ( x ) = \tilde{D} ( x ) + F ( x ) = {\sum }_{j = 1}^{n} {w}_{j} {e}^{( \frac{- {‖ x - {c}_{j} ‖}^{2}}{{r}_{j}^{2}} )} + F ( x ) \qquad ( 3 )$$

where each Gaussian is defined by its center cⱼ, radius rⱼ and weight wⱼ. A media animation is then modeled as a sequence of Gaussians and residual fields, computed in a preprocessing stage. However, preprocessing is used here for representation of the density field and it does not prevent runtime changes to media properties, lighting, or scene configuration. This representation efficiently models fine density field details, but the rendering algorithms described herein can accommodate any representation that can be rapidly reconstructed at runtime, e.g., the Gaussian+noise representation or the advected RBF (radial based function) representation, which are described elsewhere. With these alternative representations, no preprocessing would be used.

The algorithm of FIG. 2 is now reviewed with reference to the lighting model 170 of FIG. 3. For each frame in an animated sequence, the algorithm generates or computes 150 a set of sample points {xⱼ} at which to evaluate source radiance (and in some embodiments, radiance gradient). This set may be selected using a dynamic sampling strategy that results in low shading error in the rendered image by accurately reconstructing the distribution of source radiance (that is, by distributing more samples near features of the media). Details of this sampling procedure will be described in the next section. Then at each xⱼ, a volume ray tracer numerically evaluates or computes 152 the source radiance Lₓ_{ⱼ}. Gradients ∇Lₓ_{ⱼ} may be computed from the radiances. The source radiances Lₓ at other points x in the volume (non-sample points) are reconstructed using a gradient-based interpolation scheme, which is described in a later section. This interpolation yields significant improvements in quality even without the use of dynamic sampling. Finally, to reconstruct 154 the scattering medium or volume from the sample point radiances, for a given point in the medium, a ray march is performed for discrete computation of the integral in Equation (2). Implementation details of the algorithm will be given in a later section.

### Dynamically Computing Set of Sample Points

This section describes techniques to derive a relatively small set of sample points in a volumetric medium. While source radiance throughout a medium can generally be reconstructed from any arbitrary sparse set of samples, sharp shading variations tend not to be well modeled without denser sampling. However, dense sampling can be cost-prohibitive if performed globally. For accurate and efficient reconstruction, methods described in this section involve dynamically placing additional samples in areas with greater shading error, which may be evaluated according to the current sampling configuration (i.e., the current set of samples) and gradient-based interpolation.

While the techniques are useful by themselves for efficient and accurate modeling of a volume of media (i.e., deriving points to approximate structure of the media), they are particularly useful when used with a technique of gradient-based interpolation to render a model of media (as the samples can serve as a basis to interpolate radiance for most other points in the volume of media). Use of gradient-based interpolation to fully render a volume of media from samples will be discussed in the next section.

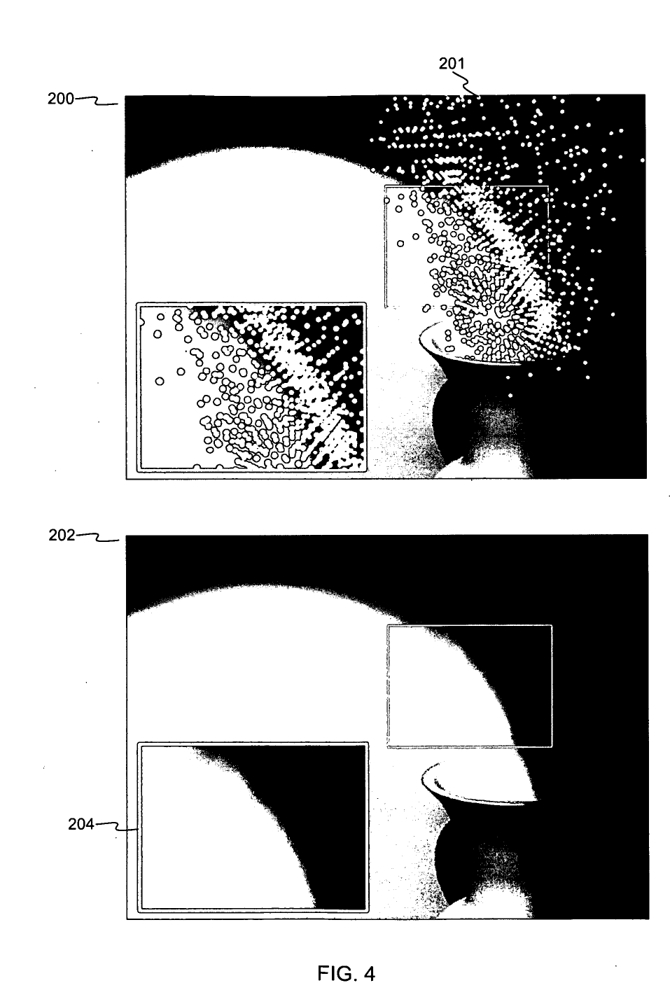

FIG. 4 shows an example of a rendered scene 200 showing a set of sample points 201 computed using dynamic sampling. The scene 200 might be one frame in an animated sequence of 3D renderings. This section will explain how sample points 201 can be computed. FIG. 4 also shows a reference rendering 202 of the same scene. The reference rendering 202 is a high precision rendering (not formed real time) shown for reference. In scene 200, a cloud of vapor is rising from a vase. A shaft of light, intersecting the scene at an angle to the page, intersects the vapor and creates the shown shading effects such as shadows in the vapor as well as a border. See inset 204. The sample points 201 in scene 200 illustrate how dynamic sampling concentrates samples in areas where there are features such as sharp light-shade borders. Over iterations of dynamic sampling, the sample points 201 increase in areas near features. Dynamic sampling will now be described in detail.

To summarize, the process for dynamic sampling is performed iteratively (preferably recursively) for each animation frame. The density field, lighting, or scene geometry may change between frames. A set of initial samples is computed for each frame to be rendered, and a number of iterations will be performed for each frame to produce an increasing number of sample points for the current frame, with higher granularity of samples occurring near shading features. During an iteration for a frame, sample points 201 are evaluated for accuracy and additional samples are added where indicated. In general, accuracy of a point is determined by using a slow but accurate algorithm (e.g. ray tracing) to compute an accurate radiance, and comparing the accurate radiance value to another radiance value of the point, which is computed by a fast but generally less accurate algorithm (e.g., by gradient interpolation). The less accurate algorithm may also be used to compute radiances for the remaining (non-sampled) points in the volumetric media.

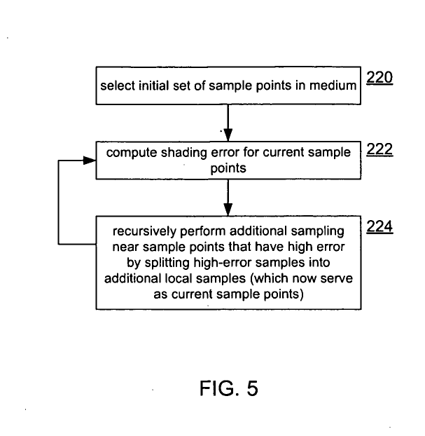

FIG. 5 shows a process for dynamically sampling points in a volume of media. After selecting 220 an initial set of points, which may be done randomly, uniformly, or otherwise, the dynamic sampling algorithm has two main steps. One step involves computing 222 a metric for local shading error within a local neighborhood of a sample. The neighborhood can be a valid sphere of the sample. The shading error metric is designed to account for discrepancies in interpolated source radiance and the errors that would result in viewed shading. In addition, this measure is designed for rapid evaluation.

The second step involves recursively performing 224 additional sampling, which in effect “splits” samples with a high shading error (according to the metrics of step 222) into multiple samples that more finely sample the local regions (e.g., valid sphere) of original samples if such samples have a large local shading error. With this adaptive resampling scheme, it is possible to accurately and efficiently model high-frequency lighting effects.

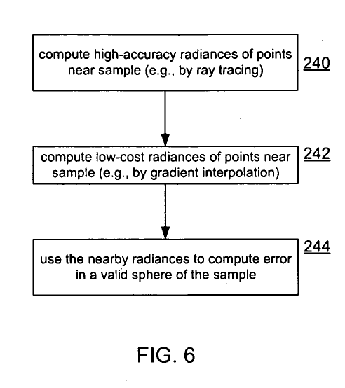

Computing 222 the local shading error of a sample point will now be described. FIG. 6 shows a general process for computing shading error for a sample point. The process of FIG. 6 may be performed for each un-tested point in the current set of sample points (that is, it may be performed for each iteration of dynamically sampling for rendering a single frame). A first algorithm may be used to compute 240 high-accuracy radiances in a local neighborhood of the current sample point. The first algorithm is preferably a slow but highly accurate algorithm, such as a ray tracing algorithm. Because only a small portion of the points in the overall volume will be sampled, a high-cost high-accuracy algorithm is acceptable. Low-cost radiances in the local neighborhood of the current sample are also computed 242. These may be computed with a second algorithm that will also be used to interpolate the radiances for the full volume of medium based on the ultimately derived set of sample points (e.g., points 201 in FIG. 4). Note that the accuracy of the second algorithm is of interest because it will be used to render most of the points in the volume of medium (e.g., by interpolation). The second algorithm might be, for example, a gradient-based interpolation, discussed in the next section. Finally, given the radiances in the local neighborhood of the current sample point, error in the low-cost radiance of the current sample point is computed 244 from the low-cost and high-cost radiances (which are presumed to be more accurate). If, based on some threshold, the error is too high for a sample point, and then the sample point can be replaced by new samples in the neighborhood of the current sample point. New samples may be added, for example, from a three-dimensional grid, from a random selection in a valid sphere of the sample point, etc. If split, the sample point may or may not be dropped from set of sample points.

In one embodiment, the shading error of a sample point due to an approximation of its source radiance, \tilde{L}ₓ, can be derived from Equation (2) as

$$δ {L}_{x} = \frac{Ω}{4 π} {\int }_{{x}_{out}}^{{x}_{i n}} D ( x ) ( {\tilde{L}}_{x} - {L}_{x} ) {τ}_{xv} d x . \qquad ( 4 )$$

For the local shading error within a valid sphere of x, an efficiently computable metric that approximately represents the total error over all the points in the sphere may be used. The local shading error of a sample j may be measured as:

$${E}_{j} = {R}_{j}^{3} {\sum }_{i = 1}^{n} \frac{\vert {\tilde{L}}_{{x}_{ij}} - {L}_{{x}_{ij}} \vert}{n} D ( {x}_{ij} ) {τ}_{{x}_{j} v} \qquad ( 5 )$$

where {xᵢⱼ} is a set of n locally sampled points within the valid sphere of radius Rⱼ, taken as {xⱼ±RⱼX, xⱼ±RⱼY, xⱼ±RⱼZ}. The factor |\tilde{L}ₓ_{ᵢⱼ}−Lₓ_{ᵢⱼ}|/n represents the average approximation error of source radiance among the sampled points. For computational efficiency, the transmittance from each of the n locally sampled points to the viewer may be approximated as that from the sphere center, τₓ_{ⱼ}ᵥ. Consider that in shading, rays are marched through the volume of the sphere, which is proportional to Rⱼ³ (which uses the estimation of the average error to approximate the total error that can be caused by the entire valid sphere). Since this metric measures local shading error with respect to a given sample point, \tilde{L}ₓ_{ᵢⱼ} may be determined by computing Equation (7) (described in the next section) using only that sample point:

\tilde{L}ₓ_{ᵢⱼ}≈Lₓ_{ⱼ}+(xᵢⱼ−xⱼ)∇Lₓ_{ⱼ} (6).

Volume tracing is used to sample source radiance values at xⱼ and the sampled points, and density values are determined by sampling the density field (i.e., the volumetric media).

Recursively performing 224 additional sampling (sample splitting) will now be described. Starting with a sample set Q⁰={cⱼ} that contains only the Gaussian centers of the samples, the local shading error Eⱼ is computed according to Equation (5) for each valid sphere. The local shading error is compared to a given threshold, ε. Within each valid sphere for which Eⱼ>ε, additional samples are added for more accurate modeling of the source radiance distribution in the medium. The set of added samples Qⱼ¹={q:q ∈ G₁ [symbol] ∥q−xⱼ∥<Rₓ_{ⱼ}} is composed of vertices of a grid G₁ that lie within the valid sphere to be resampled. The vertices from all the split samples are collected into a set Q¹=UⱼQⱼ¹, with each vertex assigned a valid radius equal to the grid interval of G₁. The sample j that was split may then be removed from Q⁰. This process proceeds by iteratively computing the local shading errors for samples in Q^{k}, and splitting those with errors greater than ε using an increasingly finer grid Gₖ₊₁. After reaching a specified maximum grid resolution (or iteration limit, or sample size), the final sample set is computed as the union of the sample sets at each grid resolution, UⱼₖQ^{k}. The corresponding set of valid spheres covers the volume of the original spheres, such that all points in the volume with significant density will be shaded. Note that the samples can be processed in parallel to obtain an acceptable performance for real-time applications.

One possible optimization would be to start generating the samples from that of the previous frame, since the consecutive frames are often temporally coherent. However, this may involve collapsing operations, which may call for an efficient GPU implementation.

A GPU implementation will now be described. The algorithm for dynamic sampling can be implemented on a GPU by combining CUDA (Compute Unified Device Architecture) and Cg shaders. The core data structure for the shaders is a renderable 3D grid information buffer that records for each vertex in the corresponding regular grid Gₖ an indicator for whether it is currently in the set Q^{k}. The core data structure additionally records the local shading error for the corresponding sample. This data structure can be passed between a CUDA kernel and OpenGL using the pixel buffer object (PBO) extension.

As discussed above, for each sample-refining iteration performed for a given frame, three basic operations are performed: sampling, filtering and splitting. In one implementation, the sampling step calls the volume ray tracer and density sampler to compute Lₓ_{ⱼ}, Lₓ_{ᵢⱼ}, ∇Lₓ_{ⱼ}, D(xᵢⱼ) and τₓ_{ⱼ}ᵥ, which are used in computing the local shading error (Equation (6)). Then, a CUDA kernel is invoked to compute the shading error and filter the samples. The scan primitive of Sengupta and Owens (“Parallel prefix sum (scan) in CUDA”, GPU Gems 3 (2007), Addison Wesley, p. Chapter 39) may be used to identify samples with errors greater than ε. Finally, these samples may be split using a standard voxelization of their valid spheres. This splitting may be implemented using the render-to-3D-texture operation. After splitting, the scan primitive is invoked again to generate the sample points for the next iteration, or to output all the samples if the maximum resolution level is reached. Note that other cutoff thresholds besides maximum resolution may be used. For example, the sampling may be cut off when the samples reach a certain average density in the volume.

Note that a pure OpenGL+CG implementation of the algorithm would also be possible, in which case the filtering CUDA kernel can be replaced with one implemented in OpenGL (see D. Horn, “Stream reduction operations for GPGPU applications”, GPU Gems 2 (2005), Addison Wesley, Chapter 36). However, this may involve many more rendering passes and redundant computations due to the absence of shared memory in a traditional graphics pipeline.

In one implementation, the maximum resolution for the regular grid was set to half that of the density field, which might be 128×128×128. Specifically, the grid resolutions in the implementation were set as follows:G₁ as 16×16×16, G₂ as 32×32×32, and G₃ as 64×64×64. For efficiency in evaluating local shading errors, the value of τₓ_{ⱼ}ᵥ for each original valid sphere defined by the Gaussian centers is used for its descendant valid spheres in computing Equation (5).

Referring again to the example of FIG. 4, a medium (vapor from a vase) illuminated by a spot light was dynamically sampled. Sampling accurately captured the sharp shading variations. Starting from an original set of 541 samples, the recursive sample splitting procedure produced a total of 2705 samples, as shown in scene 200, resulting in a faithful capture of the sharp shading variation shown in reference scene 202.

Reconstructing Medium Volume from Sample Points Using Interpolation

In this section, a real-time interpolation algorithm is described. The algorithm reconstructs the source radiance throughout the volume from a relatively small set of radiance samples in the volume. The set of samples may be samples dynamically generated as discussed in the previous section. For heightened accuracy in interpolation, the source radiance at an arbitrary point is evaluated using both the radiance values and radiance gradients of the sample points. The GPU is used to expedite this computation by calculating sampled radiance quantities in multiple threads and by splatting the samples into the volume in a manner analogous to surface radiance splatting.

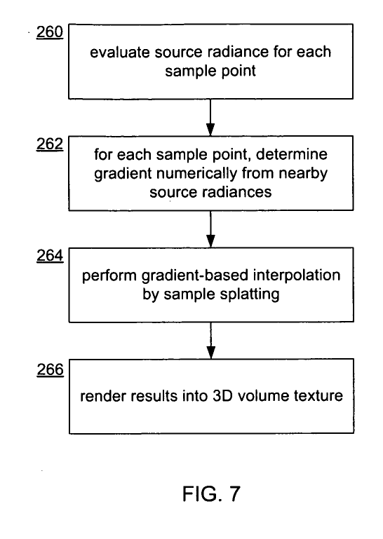

FIG. 7 shows a general process for gradient-based interpolation, to be described in detail below. Given an initial set of relatively sparse sample points, source radiance is evaluated 260 at each sample point. For each sample point, radiance gradient is determined 262 numerically from nearby source radiance samples. Gradient-based interpolation 264 is then performed by sample splatting. Finally, the results are rendered 266 into a 3D volume texture. The process of FIG. 7 may be performed for each frame in a 3D animation sequence that is being rendered in real time.

Regarding evaluation 260 of source radiance samples for gradient-based interpolation, a sample j is defined by a point xⱼ in the media volume, the source radiance Lₓ_{ⱼ} at that point, and the radiance gradient ∇Lₓ_{ⱼ}. In addition, each sample has associated with it a valid radius Rⱼ that describes the range from xⱼ within which a sample j may be used for interpolation. The sphere determined by point xⱼ and valid radius Rⱼ is referred to as the valid sphere of sample j. The set of sample points may be determined using the dynamic sampling method described previously. However, to allow comparison of the gradient-based interpolation to RBF-based interpolation, and to demonstrate that gradient-based interpolation is an effective technique independent of the method by which samples or computed, in this section the sample set is constructed from the Gaussian centers cⱼ of the density representation in Equation (3), such that xⱼ=cⱼ. The valid radius of each valid sphere is set to the culling radius of the corresponding Gaussian: Rⱼ=3rⱼ (r is the radius of the Gaussians, and at 3rⱼ, the influence of a Gaussian is less than 0.001 and can be ignored).

Evaluation 260 of source radiance and determination 262 of gradient at each sample point x will now be described. Equation (1) is used to evaluate 260 source radiance of x. In computing Equation (1), volume tracing is used for discrete integration along the ray from x to the light source sat intervals of Δ₁:

$${L}_{x} = \frac{{I}_{0}}{4 π {d}_{sv}^{2}} {e}^{( - {σ}_{t} {Δ}_{1} {\sum }_{u ∈ 𝕌} D ( u ) )}$$

$$𝕌 = \{ {u}_{k} \text{:} {u}_{k} = x + vk {Δ}_{1} , k = 0 , 1 , … ⌊ ‖ s - x ‖ / {Δ}_{1} ⌋ , {u}_{k} ∈ 𝕍 \}$$

where v=(s−x)/∥s−x∥ represents the ray direction. At each volume tracing step, the density is obtained from the density field and accumulated into the running sum until u exits the volume V. The transmittance is then evaluated and multiplied by I₀/(4πdₛᵥ²) to yield radiance Lₓ.

The gradient is determined 262 numerically from the source radiance values at six points surrounding x along the three axis directions X, Y, Z:

$$∇ {L}_{x} = ( \begin{matrix}\frac{{L}_{x + {Δ}_{2} X} - {L}_{x - {Δ}_{2} X}}{2 {Δ}_{2}} , \\ \frac{{L}_{x + {Δ}_{2} Y} - {L}_{x - {Δ}_{2} Y}}{2 {Δ}_{2}} , \\ \frac{{L}_{x + {Δ}_{2} Z} - {L}_{x - {Δ}_{2} Z}}{2 {Δ}_{2}}\end{matrix} ) .$$

Note that the source radiances at the various sample points may be computed in parallel on the GPU. Also, the precision of this numerical evaluation may be controlled by user defined intervals Δ₁ and Δ₂. The tracing step Δ₁ is in inverse proportion to the performance of volume tracing. In one implementation, Δ/2 is used for Δ₁ and Δ is used for Δ₂, where Δ is the distance between neighboring grid points in the volume.

Gradient-based interpolation 264 by sample splatting will now be described. With the computed radiance and gradient values of Lₓ_{ⱼ} and ∇Lₓ_{ⱼ} at each sample point xⱼ, the radiance Lₓ at an arbitrary point x is computed as a weighted average of the first-order Taylor approximations evaluated from each contributing sample to x,

Lₓ=Σ_{S}Wⱼ(x) (Lₓ_{ⱼ}+(x−xⱼ)·∇Lₓ_{ⱼ})/Σ_{S}Wⱼ(x)

S={j:∥x−xⱼ∥<Rⱼ}, Wⱼ(x)=Rⱼ/∥x−xⱼ∥. (7)

In interpolating the source radiance of an arbitrary point x (a non-sample point), rather than directly retrieve samples whose valid sphere covers x, the GPU may be utilized to splat the samples into the volume. First, the valid sphere of each sample is intersected with each X−Y slice of the volume, with +Z aligned to the viewing axis. The bounding quads of the intersection circles are found and grouped by slices. Then, for each slice, these bounding quads are rendered with alpha blending enabled (this is the splatting). For each pixel whose radiance is to be interpolated, the weighted approximate radiance Wⱼ(x)(Lₓ_{ⱼ}+(xⱼ−x)·∇Lₓ_{ⱼ}) and the weighting function Wⱼ(x) are evaluated and accumulated. Rendering all bounding quads for a slice yields the numerator and denominator of Equation (7), from which Lₓ is computed. The bounding quad of all intersection circles in the slice is then rendered, with Lₓ evaluated at each pixel. The result is rendered 266 into a 3D volume texture.

### Implementation Details

This section, describes some implementation details of a rendering pipeline configured to perform the methods and embodiments mentioned above.

Regarding density field construction, for each frame, the density field may be constructed by splatting, with a process similar to the radiance splatting described in the previous section. Here, the weight wⱼ of each Gaussian is splatted instead of the sampled radiance. Note that splatting refers to rendering a number of primitives, often overlapped, with alpha blending. Unlike the gradient-based interpolation, no weight normalization is called for. If a residual field hash table exists, splatting may be performed with it as well, by retrieving R(x) from the hash table, multiplying it by \tilde{D}(x), and saving it in another color channel. Thus after splatting we have \tilde{D}(x) and R(x)\tilde{D}(x) in different color channels. Dividing the latter by the former gives R(x), and adding R(x) to \tilde{D}(x) yields D(x). Note that it may not be possible to obtain R(x) directly in the first pass since the alpha blending is set to (GL_ONE, GL_ONE) during the splatting.

For volume ray tracing, tracing can be conducted for all sample points in a single call. This may be done by first packing the sample points into a 2D texture. A quad of the same size is drawn to trigger the pixel shader, in which volume ray tracing is performed as described in the previous section. To further improve performance, the tracing of a ray may be terminated if it exits the volume.

Regarding ray marching, given the density field and the source radiance field, a ray march is conducted. Radial based functions (RBFs) of the density representation are intersected with slices of thickness Δx that are perpendicular to the view direction (the thickness of each slice is set to the distance between neighboring grid points in the volume). Then the slices are rendered from far to near, with alpha blending set to GL_ONE and GL_SRC_ALPHA. The bounding quad of all intersections with the RBFs in each slice is rendered. For each pixel, D(x) and Lx are retrieved from 3D textures, and the RGB channels of the output are set to D(x)Lₓ. The alpha channel is set to the differential transmittance of the slice, computed as e^{-σ}^{ₜ}^{D(x)Δx}. After all slices are rendered, a discrete version of the integration in Equation (1) is obtained.

Regarding scenarios where scene objects are present in the medium, Equation (2) may be modified to

L=LₛVₛᵥ+LₚVₛₚ+∫ₚ^{X}^{ᵢₙ}σₜD(x)LₓVₛₓτₓᵥdx, (8)

where p is the first intersection of the view ray with a scene object, and Lₚ is the reflected radiance from the surface, computed as I₀τₛₚρ(\vec{s−p}, \vec{N})/dₛₚ². The visibility term V_{ab} is a binary function that evaluates to 1 if there exists no scene object blocking a from b, and is equal to 0 otherwise. If the view ray does not intersect a scene object, then p is set to infinity and Lₚ is 0.

Scene objects can affect the computation of L in three ways. First, visibility terms should be incorporated, and can lead to volumetric and cast shadows. Second, they give rise to a new background radiance term Lₚ. And finally, they determine the starting point of the integration in Equation (8).

To account for the visibility term, shadow mapping may be used with a small modification made to the volume tracer. A comparison of ∥s−x∥ may be added to the depth recorded in the shadow map, and exit tracing if ∥s−x∥ is larger, i.e., x is occluded from s. Note that this modification works for both the dynamic sampling algorithm and the interpolation algorithm. In one implementation, variance shadow mapping (Donnelly and Lauritzen, “Variance shadow maps”, In Proc. of SI3D 06 (2006), pp. 161-165.) may be used to reduce aliasing.

To compute Lₚ on the object surface, the same volume tracer may be used. For this, surface radiance splatting could be used. However, since direct but not indirect illumination is computed, much denser sampling would likely be required. High curvature regions on the object can also be problematic. Thus, in one implementation it may be assumed that all scene objects are triangulated to a proper scale, and the graphics hardware is allowed to linearly interpolate the sampled reflected radiance at vertices. Note that it is possible to interpolate the transmission τₛₚ and apply arbitrary per-pixel shading when computing Lₚ.

To account for scene objects in ray marching, the objects may be drawn before ray marching, and then depth culling built into the GPU may be leveraged to correctly attenuate the reflected radiance Lₚ and exclude slices behind p.

### CONCLUSION

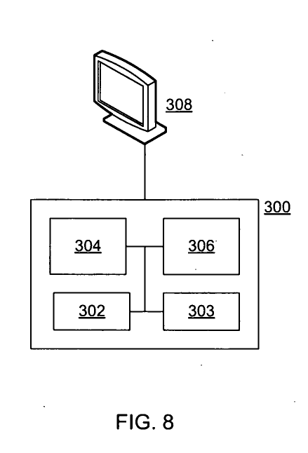

FIG. 8 shows an example computing device 300 on which various methods described above may be implemented. Computing device 300 may include a CPU 302 and GPU 303, storage media including volatile working memory 304 and or non-volatile storage 306. A display 308 may be included to display images rendered per embodiments described above.

Embodiments and features described above can be realized in the form of information stored in volatile 304 and/or non-volatile 306 computer or device readable storage media. This is deemed to include at least media such as optical storage (e.g., CD-ROM), magnetic media, flash ROM, RAM drives, or any current or future means of storing digital information for rapid access by a computing device. The stored information can be in the form of machine executable instructions (e.g., compiled executable binary code), source code, bytecode, or any other information that can be used to enable or configure computing devices to perform the various embodiments described above. This is also deemed to include at least volatile memory such as RAM and/or virtual memory storing information such as CPU instructions during execution of a program carrying out an embodiment, as well as non-volatile media storing information that allows a program or executable to be loaded and executed. The embodiments and featured can be performed on any type of computing device, including portable devices, workstations, servers, mobile wireless devices, and so on.

1. A computer-implemented method for 3D rendering a frame for animating a 3D scene comprising a volume of scattering media radiating light in accordance with a light source, the method comprising:
dynamically sampling the volume of scattering media to compute a set of sample points, each sample point comprising a source radiance and radiance gradient according to the volume of scattering media and the light source; and
computing radiances of points in the volume of scattering media by interpolating from the source radiances and radiance gradients of the sample points.

2. A computer-implemented method according to claim 1, the interpolating further comprising splatting the sample points into the volume of scattering media.

3. A computer-implemented method according to claim 1, the dynamically sampling comprising using a first algorithm to compute first source radiances of the sample points, and using a second algorithm to compute second radiances of the sample points.

4. A computer-implemented method according to claim 3, further comprising determining whether to generate additional sample points near a sample point based on one or more of the first source radiances and based on one or more of the second source radiances.

5. A computer-implemented method according to claim 4, wherein the first algorithm comprises a ray-tracing algorithm that uses ray-tracing to compute the first source radiances, and the second algorithm comprises an interpolation algorithm that uses interpolation, where the first and second source radiances are used to compute shading errors at the respective sample points, and where the shading errors are used to determine whether to generate additional sample points.

6. A computer-implemented method according to claim 1, wherein the method is repeatedly performed in real-time to render frames for real-time animation of the 3D scene.

7. One or more volatile and/or non-volatile storage media storing information to enable a computing device to perform a process of dynamically sampling a volume of scattering media in a 3D model of a 3D scene, the process comprising:
providing a set of 3D sample points in the density field;
determining whether to add additional samples to the set of 3D sample points by determining shading errors local to the sample points, respectively;
adding new points near sample points with a shading error above a threshold;
not adding new points near sample points having a shading error below the threshold; and
using the set of 3D sample points, including the added new points, to render the volume of scattering media by computing radiances of points in the volume of scattering media.

8. One or more volatile and/or non-volatile storage media according to claim 7, wherein the shading errors are computed based on source radiance values of the sample points as determined by ray tracing in accordance with a light source and properties of the volume of scattering media.

9. One or more volatile and/or non-volatile storage media according to claim 8, wherein the shading errors correspond to differences between radiances of the sample point based on interpolation and radiances based on ray-tracing.

10. One or more volatile and/or non-volatile storage media according to claim 7, wherein the rendering is performed by interpolation of radiances and radiance gradients of the sample points.

11. One or more volatile and/or non-volatile storage media according to claim 10, wherein the rendering is further performed by splatting the sample points into the volume of scattering media.

12. One or more volatile and/or non-volatile storage media according to claim 11, wherein the volume of scattering media is represented by a density field and the density field is reconstructed by splatting Gaussian weights of the sample points.

13. One or more volatile and/or non-volatile storage media according to claim 7, wherein the 3D sample points are computed by iteratively refining the sample points in a manner that causes sample points to be concentrated near features of the volume of scattering media.

14. One or more volatile and/or non-volatile storage media storing information to enable a computing device to perform a process of rendering a volume of scattering media given information representing the volume of scattering media, a light source, and a set of 3D sample points in the volume of scattering media, the process comprising:
computing a source radiance for each sample point;
for each sample point, determining a corresponding radiance gradient from source radiances of sample points near the sample point;
from the source radiances and radiance gradients of the sample points, interpolating radiances of points in the volume of scattering media, by, for a given point, splatting sample points into the volume of scattering media; and
rendering the volume of scattering media in accordance with the interpolated radiances.

15. One or more volatile and/or non-volatile storage media according to claim 14, wherein the splatting is performed by rendering portions of the volume with alpha blending enabled.

16. One or more volatile and/or non-volatile storage media according to claim 14, wherein the source radiance of a sample point is computed by tracing a ray in the volume from the sample point to the light source.

17. One or more volatile and/or non-volatile storage media according to claim 14, wherein the sample points are obtained by iteratively sampling in the volume of scattering media in a way that increases sample density in regions of the volume of scattering media according to computed local shading errors in the regions.

18. One or more volatile and/or non-volatile storage media according to claim 14, further comprising repeating the steps of the method for different frames of an animation to animate a 3D scene in real time.

19. One or more volatile and/or non-volatile storage media according to claim 14, wherein the volume of scattering media comprises a density field and the density field is constructed by splatting.

20. One or more volatile and/or non-volatile storage media according to claim 19, wherein the interpolated radiance of a point is based on radiance gradients and source radiances of samples in a local neighborhood of the point.
